(19) United States
(12) Patent Application Publication
(10) Pub. No.: US 2015/0071590 A1
(43) Pub. Date: Mar. 12, 2015

(54) ROTATABLE CONNECTOR AND ASSEMBLY METHODS

(71) Applicant: Volex plc, London (GB)

(72) Inventors: Deng Jin Wu, Shenzhen (CN); Mui Lian Jessica Toh, Singapore (SG); Agapito G. Lontoc, JR., Laguna (PH)

(21) Appl. No.: 14/484,148

(22) Filed: Sep. 11, 2014

Related U.S. Application Data
(60) Provisional application No. 61/877,214, filed on Sep. 12, 2013.

(51) Int. Cl. H01R 13/58; H01R 43/16; H01R 43/02; G02B 6/36

(52) U.S. Cl. CPC H01R 13/5841; G02B 6/3604; H01R 43/16; H01R 43/0207
USPC 385/56; 439/31; 29/876; 29/879; 29/877; 29/428

(57) ABSTRACT

A rotatable power/signal connector includes a fixing part and a rotating part. The fixing part comprises a housing portion in which a set of terminals is mounted for terminating conduits, an upper inner cover with recesses for receiving a first resilient member and a first gear, and a lower inner cover with recesses for receiving a second resilient member and a second gear. The rotating part comprises an upper outer cover with the first gear, a lower outer cover with the second gear, the first resilient member, and the second resilient member. The rotating part is rotatable relative to the fixing part and fixable to the fixing part at a number of predetermined positions.

### CROSS REFERENCE TO RELATED APPLICATIONS

This application claims benefit under 35 U.S.C. §119(e) of Provisional U.S. patent application No. 61/877,214, filed Sep. 12, 2013, the contents of which is incorporated herein by reference in its entirety.

### TECHNICAL FIELD

The present disclosure relates to connectors for providing an electrical power connection or electrical or optical signal connections. In particular, it relates to a rotatable connector and assembly methods therefore.

### BACKGROUND

An electrical connector is used to attach an electronic device, such as an appliance or other powered device, to its power source. Conventional electrical connectors have electrically conductive terminals connected to a power cable and fixed together in a housing. When in use, the electrical connector is engaged with an inlet for the electronic device, which is mounted on or within the device so as to supply electrical power to the device. The conventional electrical connector has a working angle of engagement with the inlet.

Users often encounter difficulties when using conventional electrical connectors, in particular when access to a device inlet is constrained due to limited space availability or the inlet is blocked by surrounding items, such as other power cables. In such situations, in order to connect to the inlet, the power cable may have to be routed around the blockage or, if not long enough, the power cable may be forced to bend to accommodate the constrained or blocked access space. This may result in the connector being loosely fitted or becoming loose or disengaged from the inlet over time, thereby causing poor electrical connections or even power supply failure.

Likewise, signal connectors, such as data connectors, optical connectors and other forms of connectors used in a wide variety of industries, such as telecommunications, computing, consumer electronics, etc., have difficulties similar to those of electrical power connectors, where there is insufficient room for the cabling connected to the connector to project straight out from the connector.

It is therefore desirable to provide an improved connector that enables users to select a suitable and convenient angle of engagement with an inlet, depending on the conditions of the surrounding items and space available.

### SUMMARY

The present disclosure aims at overcoming the weaknesses of conventional connectors and providing a rotatable connector with a plurality of working positions.

A rotatable connector according to embodiments of the present disclosure includes a fixing part and a rotating part. The fixing part comprises a housing portion in which a set of electrical/optical terminals may be mounted for supplying electrical power or electrical/optical signals, an upper inner cover with recesses for receiving a first resilient member and a first gear, and a lower inner cover with recesses for receiving a second resilient member and a second gear. The rotating part comprises an upper outer cover with the first gear, a lower outer cover with the second gear, the first resilient member, and the second resilient member. The rotating part is rotatable relative to the fixing part and fixable to the fixing part at a predetermined position.

A method for assembling a rotatable connector of the present disclosure comprises the steps of assembling a first resilient member onto an upper inner cover, assembling a second resilient member onto an lower inner cover, assembling a upper outer cover with a first gear into the upper inner cover, and assembling a lower outer cover with a second gear into the lower inner cover.

A rotatable connector of the present disclosure has a plurality of working positions, which enables users to select a suitable and convenient angle of engagement with an inlet. Routing or force bending of the power/electrical/optical cable due to space constraint may be avoided. Access to an inlet is more convenient, and power/signal supply reliability is improved.

### BRIEF DESCRIPTION OF THE DRAWINGS

Embodiments of the present disclosure will be described more fully hereinafter with reference to the accompanying drawings, in which:

FIG. 1A is a perspective view showing a rotatable electrical connector of the present disclosure, when the fixing part and the rotating part keep in a straight line;

FIG. 1B is a perspective view showing a rotatable electrical connector of the present disclosure, when the rotating part swivels to the right 45° relative to the fixing part;

FIG. 1C is a perspective view showing a rotatable electrical connector of the present disclosure, when the rotating part swivels to the right 90° relative to the fixing part;

FIG. 1D is a perspective view showing a rotatable electrical connector of the present disclosure, when the rotating part swivels to the left 45° relative to the fixing part;

FIG. 1E is a perspective view showing a rotatable electrical connector of the present disclosure, when the rotating part swivels to the left 90° relative to the fixing part;

FIG. 2 is an exploded perspective view showing the rotatable electrical connector of FIG. 1A;

FIGS. 3A and 3B are perspective views showing structures of upper and lower inner covers;

FIG. 4 is a perspective view showing a structure of an outer cover;

FIG. 5 is a perspective view showing a structure of a metal spring;

FIG. 6A is a top view showing the rotatable electrical connector of FIG. 1A;

FIG. 6B is a partial cross-sectional view of FIG. 1A;

FIG. 7A is a partial perspective view showing an internal structure of the rotating part of a rotatable electrical connector of FIG. 1A;

FIG. 7B is a partial perspective view showing an internal structure of the rotating part of a rotatable electrical connector of FIG. 1B;

FIG. 7C is a partial perspective view showing an internal structure of the rotating part of a rotatable electrical connector of FIG. 1C;

FIGS. 8A and 8B are perspective views showing the process of assembling two metal springs onto the inner covers of a rotatable electrical connector; and

FIGS. 9A and 9B are perspective views showing the process of assembling the outer covers into the inner covers of a rotatable electrical connector.

### DETAILED DESCRIPTION OF ILLUSTRATIVE EMBODIMENTS

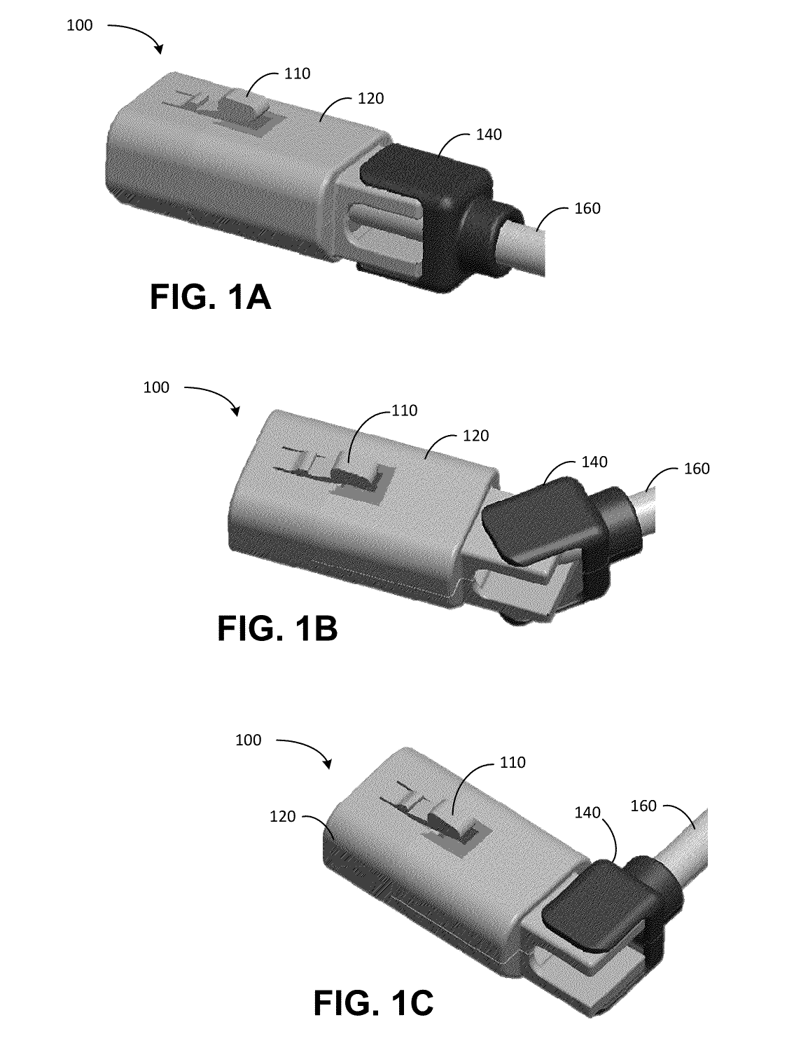

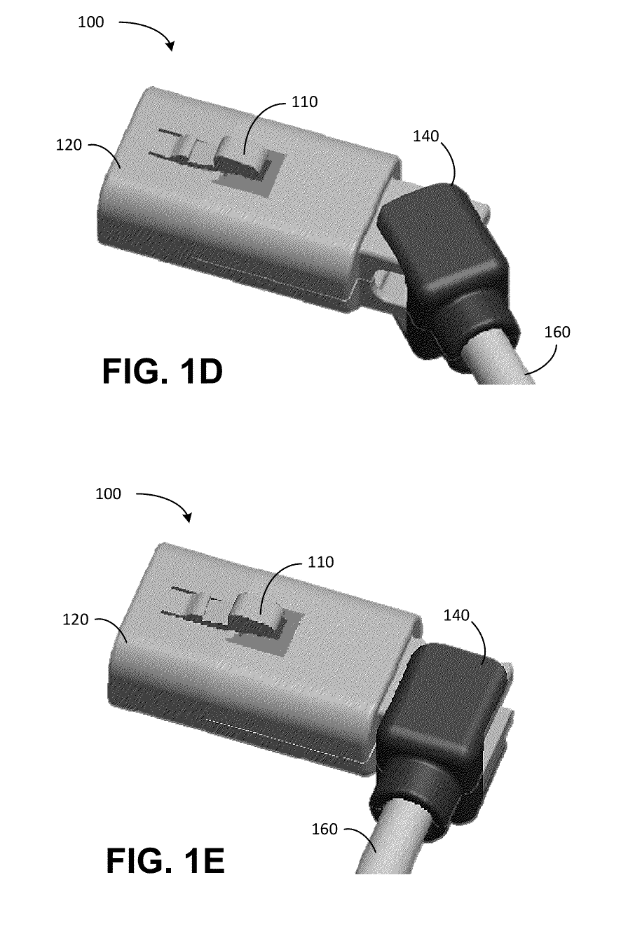

While embodiments of an electrical power connector, for convenience and simplicity, are illustrated in the drawings and described herein, it is to be understood that the present disclosure is not limited to electrical power connectors and could equally apply to any type of signal/data connector. As shown in FIGS. 1A, 1B, 1C, 1D, and 1E, a rotatable electrical connector 100 according to the present disclosure includes a fixing or fixed part 120 and a rotating part 140. Optionally, a resilient locking member 110 may be formed on the fixing part 120. The locking member 110 is configured to lock the electrical connector 100 relative to an inlet, and permit selective unlocking of the connector 100 from the inlet and thereby allow withdrawal of the connector 100 from the inlet. A power cable 160 is connected to the fixing part 120, through the rotating part 140, so as to supply power to the connector 100 during use. The rotating part 140 is coupled to the fixing part 120. The rotating part 140 is rotatable relative to the fixing part 120 and is fixable to the fixing part 120 at a plurality of predetermined positions, such as at 0°, right 45°, right 90°, left 45°, and left 90° positions. In other embodiments, the rotating part 140 can swivel to any other suitable angles relative to the fixing part 120 and be fixed at any other suitable positions, depending on the shape and/or number of teeth in the gears further described below.

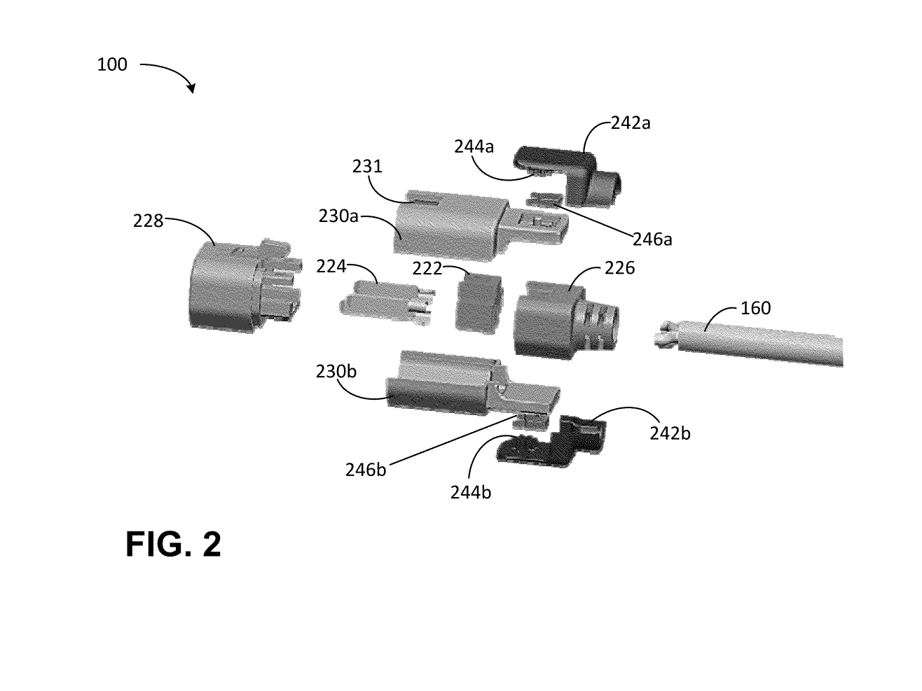

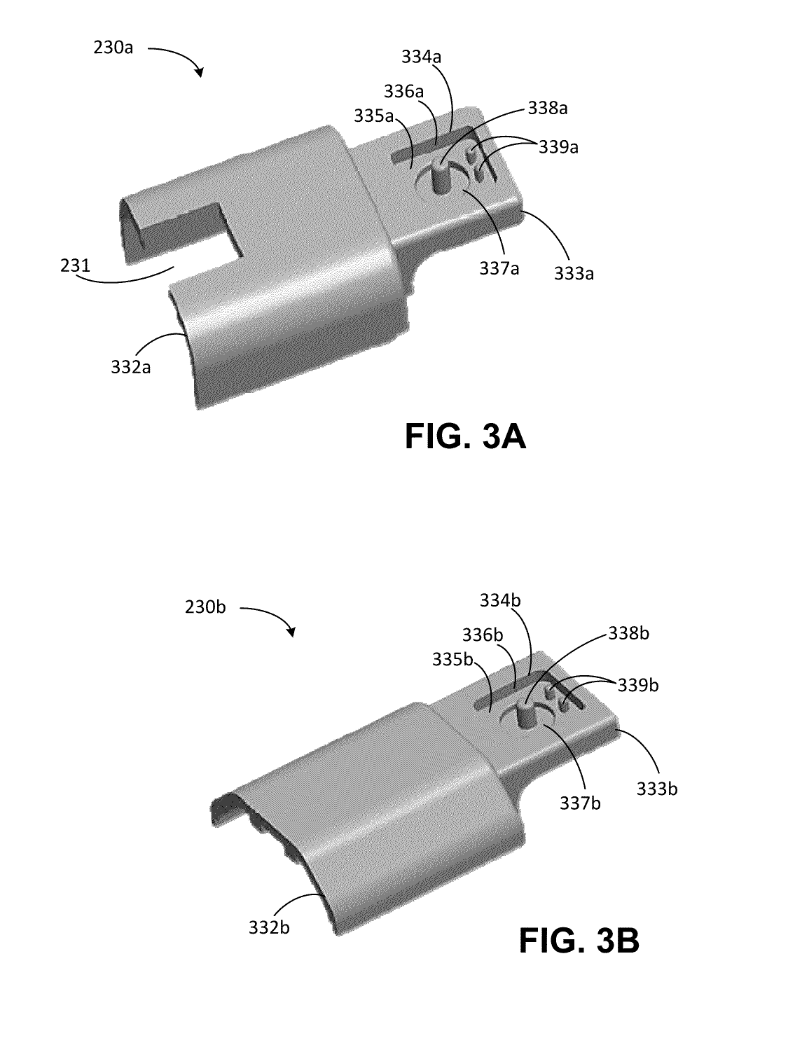

As shown in FIG. 2, the rotatable electrical connector 100 may comprise an inner housing 222, a set of electrical terminals 224, an outer mold 226, an outer housing 228, an upper inner cover 230a, a lower inner cover 230b, an upper outer cover 242a with a gear 244a, a lower outer cover 242b with a gear 244b, and a pair of metal springs 246a and 246b. A housing portion may consist of the inner housing 222 and the outer housing 228. The inner housing 222 may be provided with a set of electrical terminals 224 in electrical connection with the power cable 160, which supplies power to the connector 100 during use. In the event the connector 100 is utilized for some application other than just electrical power, the terminals 224 could be any other form of terminating device for a conduit, such as a power line, a data line, optical line, or any combination thereof. The outer mold 226 may be formed over the inner housing 222 using a conventional over molding process. The outer housing 228 may be coupled to the inner housing 222 and may be configured to hold the set of electrical terminals 224. In an embodiment, the resilient locking member 110 of FIGS. 1A, 1B, 1C, 1D and 1E may be integrally formed with the outer housing 228. A rectangular-shaped opening 231 may be formed at one end (end portion 332a of FIG. 3A) of upper inner cover 230a so as to receive the button portion of the locking member 110. The upper and lower inner covers 230a and 230b may be configured to cover the outer mold 226 and may be coupled to the outer housing 228.

As shown in FIG. 3A and 3B, the upper inner cover 230a may comprise the end portion 332a and another end portion 333a; the lower inner cover 230b may comprise one end portion 332b and another end portion 333b. Rectangular-shaped recesses 334a and 334b may be formed in the end portion 333a and 333b, respectively. The recesses 334a and 334b may be other shapes, such as a square. Each rectangular-shaped recess may comprise a bottom portion 335a or 335b and walls 336a or 336b surrounding the bottom portions 335a and 335b. Substantially circular recesses 337a and 337b may further be formed in the bottom portions 335a and 335b of the rectangular-shaped recesses 334a and 334b, respectively. Columns 338a and 338b may be formed substantially at the centers of the circular recesses 337a and 337b, respectively. Two pairs of pillars 339a and 339b may be provided at the rectangular-shaped recess bottom portions 335a and 335b, respectively. Each pair of pillars may be outside of, but adjacent to, the circular recesses 337a or 337b. The center between each pair of pillars 339a and 339b may be generally aligned with the center of each corresponding circular recess 337a and 337b, respectively. The columns 338a and 338b and the pair of pillars 339a and 339b may be formed of any appropriate shape and size and need not be cylindrical as shown herein.

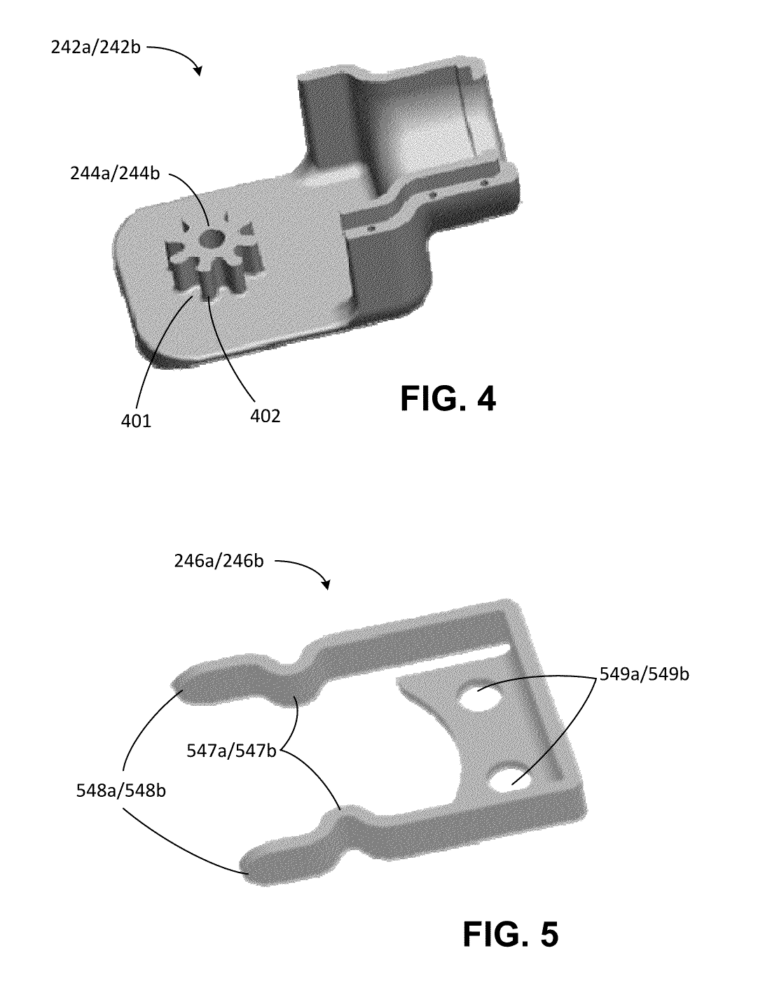

As shown in FIG. 2, and more particularly in FIG. 4, the gears 244a/244b may be formed on the inward surface at one end of the upper/lower outer covers 242a/242b. Preferably, the gears 244a/244b and the upper/lower outer covers 242a/242b may be formed of one piece of insulating material, such as plastic. Optionally, the gears 244a/244b and the upper/lower outer covers 242a/242b may be separately formed and then fixed together by any suitable means, such as welding and gluing. In one embodiment, illustrated in FIG. 4, eight teeth 402 and notches 401 are provided in the gears 244a/244b. It should be appreciated that any number of teeth 402 and notches 401, other than eight, may be formed as alternatives, for example 12 or other numbers, with different number of teeth/notches effecting the angles possible between the fixing part 120 and the rotating part 140. The gears 244a/244b may be assembled into the circular recesses 337a/337b of the upper inner cover 230a and lower inner cover 230b, respectively.

As shown in FIG. 2, and more particularly in FIG. 5, the metal springs 246a and 246b may each include a pair of legs 548a/548b that each include a tip 547a/547b, forming an opposing pair of tips. The pair of tips 547a/547b may be engaged with corresponding notches 401 between teeth 402 of the gears 244a, as shown in FIG. 4, during use so as to keep the fixing part 120 and the rotating part 140 of FIG. 1A at a certain desired angle. Gears 244b may include similar notches 401 and teeth 402 as gears 244a. A pair of circular holes 549a/549b may be formed in a flat element positioned at one end of the metal springs 246a/246b. The pair of circular holes 549a/549b may be fitted onto the pair of pillars 339a/339b, shown in FIGS. 3A and 3B, so as to assemble the metal springs 246a/246b on the upper inner cover 230a or the lower inner cover 230b, respectively. The metal springs 246a/246b may be made of any suitable material, such as SUS304, and need not be made of metal, even though it may be called a metal spring herein, if another suitable material would provide the same amount of resistive elasticity.

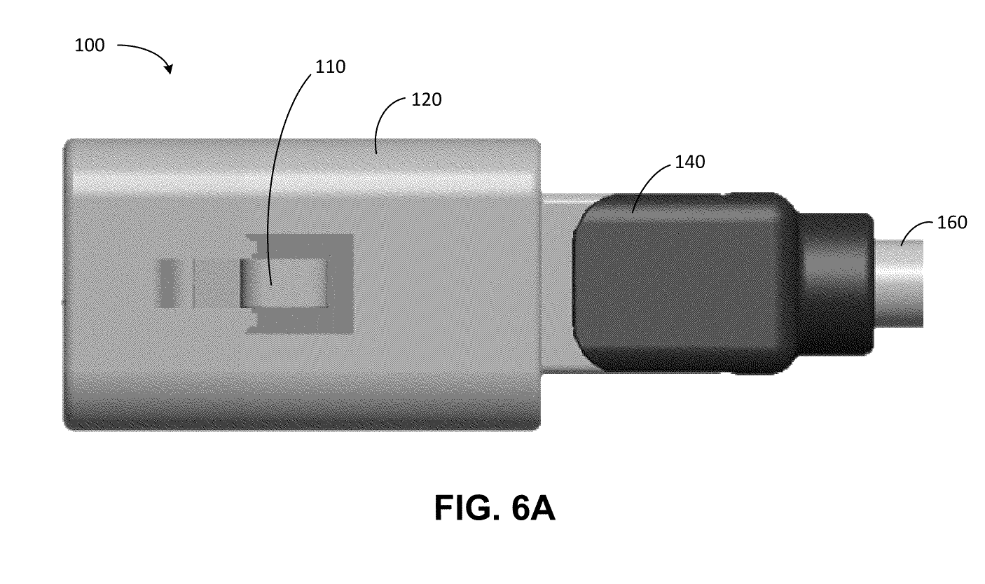

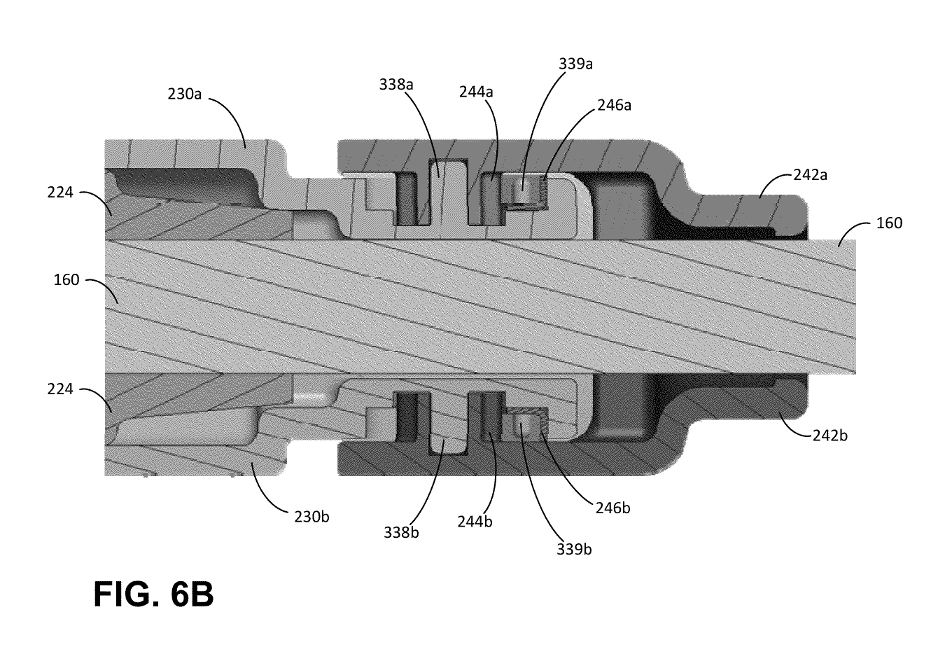

As shown in FIGS. 3A, 3B, 6B, 7A, 7C, 8A and 8B the metal springs 246a and 246b may be installed into the rectangular-shaped recesses 334a and 334b (shown in FIGS. 3A and 3B) of the inner covers 230a and 230b by fitting each pair of circular holes 549a and 549b onto each corresponding pair of pillars 339a and 339b, respectively. The gears 244a and 244b on the outer covers 242a and 242b may then be installed into the circular recesses 337a and 337b of the inner covers 230a and 230b, respectively, so as to hold the metal springs 246a and 246b in place. The metal springs 246a and 246b may act against the gears 244a and 244b, respectively, with the pair of tips 547a and 547b being engaged with certain gear notches 401. By virtue of this arrangement, the rotating part 140 may be prevented from free rotation, but may be rotated by overcoming the spring force exerted by the metal springs 246a and 246b, typically through an action of a user. In the embodiment with eight notches 401 being provided in each of the gears 244a and 244b, the rotating part 140 may be fixed at 0°, right 45°, right 90°, left 45°, and left 90° positions relative to the fixing part 120. It should be appreciated that notches 401 other than eight may be formed as alternatives, such as 12 or other numbers, and with fixing angles 0°, right 30°, right 60°, right 90°, left 30°, left 60°, left 90°, or other corresponding fixing positions.

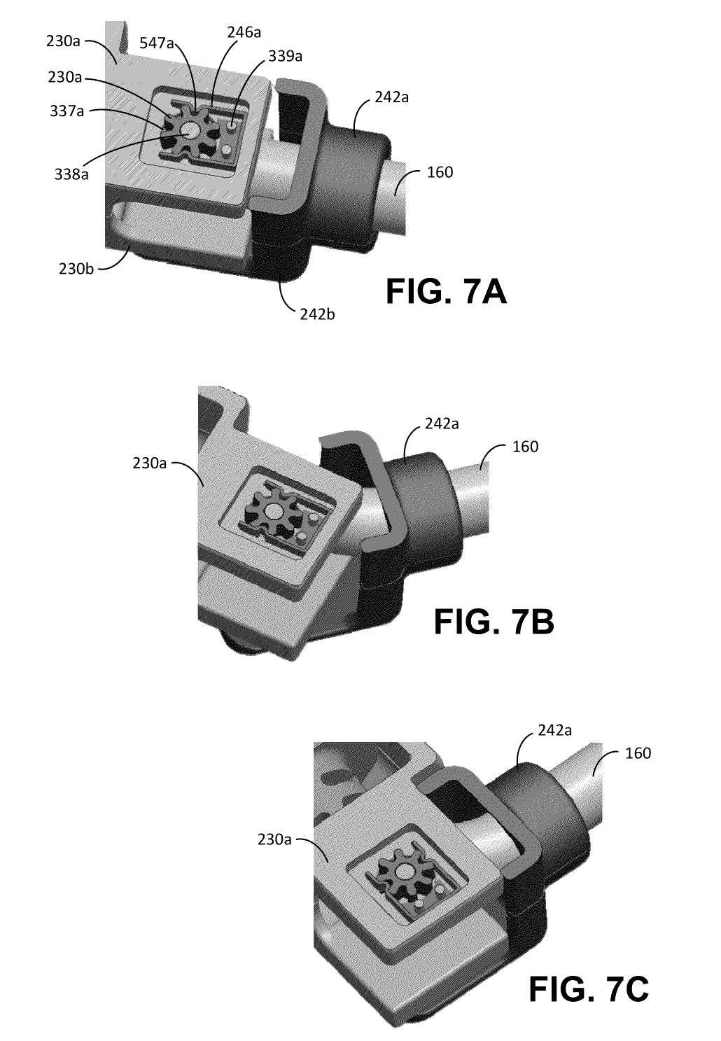

By way of example without limitation, as shown in FIG. 7B, when a user turns the outer covers to the right (relative to the fixing part 120) by hand, the metal springs may be opened by the external force acting against the teeth 402 until the outer covers are turned to the right 45° position, where the pair of tips of the metal springs may be engaged with the gear notches 401 again. As a result, the rotating part 140 may be locked at the right 45° position relative to the fixing part 120. As shown in FIG. 7C, when the user continues to turn the outer covers to the right, the metal springs may be opened by the external force again acting upon the teeth 402 until the outer covers are turned to the right 90° position where the pair of tips of the metal springs may be engaged with the gear notches 401 again. As a result, the rotating part 140 may be locked at the right 90° position relative to the fixing part 120. In a similar way, the rotating part 140 may swivel to the left 45° relative to the fixing part 120 and be locked there. Likewise, the rotating part 140 may continue to swivel to the left 90° relative to the fixing part 120 and be locked there.

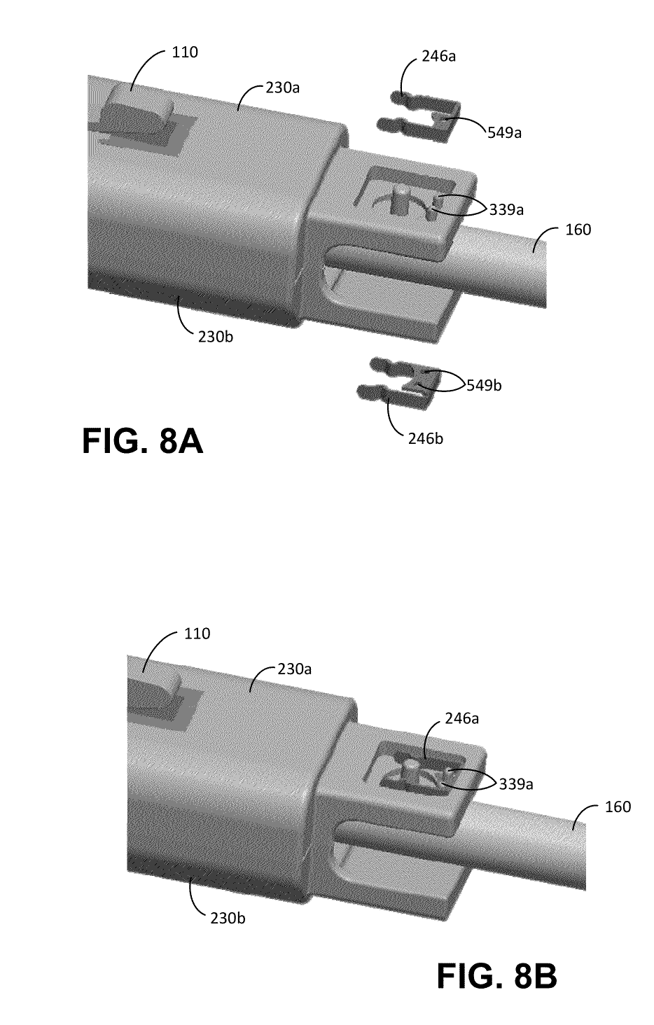

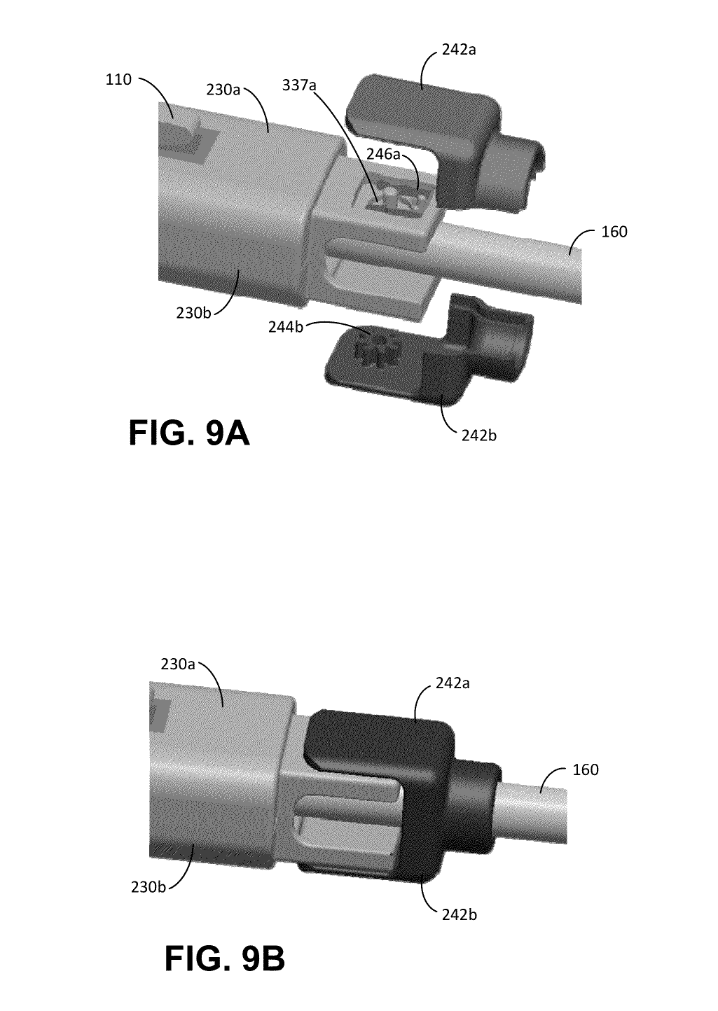

As shown in FIGS. 8A and 8B and FIGS. 9A and 9B, a method for assembling the rotatable connector 100 may comprise the steps of assembling the metal springs and assembling the outer covers onto the inner covers. The two metal springs 246a and 246b may be assembled on the upper and lower inner covers 230a and 230b by fitting each pair of circular holes 549a and 549b onto each corresponding pair of pillars 339a and 339b (not shown in FIGS. 8A and 8B and 9A and 9B), respectively. After the two metal springs 246a and 246b are in place, they may be fixed on the inner covers 230a and 230b by the presence of the outer covers 242a and 242b or by ultrasonic welding or any other suitable means. The outer covers 242a and 242b may then be assembled onto the inner covers 230a and 230b by fitting the gears 244a and 244b into the circular recesses 337a and 337b, respectively. After the outer covers 242a and 242b are in place, they may be fixed onto the inner covers 230a and 230b by ultrasonic welding, adhesives, or any other suitable means.

In an embodiment described herein, a power/signal connector, comprises: a fixing part for connection to an inlet comprising: a housing portion having a set of terminals mounted in the housing portion for terminating conduits; an upper inner cover with recesses formed therein for receiving a first resilient member and a first gear; a lower inner cover with recesses formed therein for receiving a second resilient member and a second gear; and a rotating part being rotatable relative to the fixing part at three or more predetermined positions, the rotating part including: an upper outer cover having the first gear; a lower outer cover having the second gear; the first resilient member; and the second resilient member.

In the embodiment, the fixing part further includes a resilient locking member for locking the fixing part relative to the inlet. In the embodiment, a first recess among the recesses formed in each of the inner covers includes a substantially rectangular-shaped recess and a substantially circular recess. In the embodiment, each of the inner covers further comprises a pair of pillars for positioning each of the resilient members within the recesses. In the embodiment, each of the resilient members has a pair of circular holes formed therein for mating with the pair of pillars. In the embodiment, each of the gears includes a plurality of teeth with notches formed between a pair of teeth, at least one notch and a corresponding pair of teeth being configured to engage with a corresponding one of the resilient members so as to resiliently hold the fixing part at one of the three or more predetermined positions.

In the embodiment, each of the resilient members includes a pair of opposing tips for engaging with a pair of opposing notches and corresponding pairs of opposing teeth. In the embodiment, a position among the three or more predetermined positions is a straight line along a length of the fixing part and a length of the rotating part. In the embodiment, a position among the three or more predetermined positions is a 45 degree angle between a length of the fixing part and right of a length of the rotating part. In the embodiment, a position among the three or more predetermined positions is a 45 degree angle between a length of the fixing part and left of a length of the rotating part. In the embodiment, a position among the three or more predetermined positions is a 90 degree angle between a length of the fixing part and right of a length of the rotating part. In the embodiment, a position among the three or more predetermined positions is a 90 degree angle between a length of the fixing part and left of a length of the rotating part.

In an embodiment described herein, a method for assembling a rotatable power/signal connector, comprises: assembling a first resilient member on an upper inner cover by fitting the first resilient member into a first recess formed within the upper inner cover; assembling a second resilient member on a lower inner cover by fitting the second resilient member into a first recess formed within the lower inner cover; assembling an upper outer cover over the upper inner cover by fitting a first gear into a second recess formed within the upper inner cover; and assembling a lower outer cover over the lower inner cover by fitting a second gear into a second recess provided within the lower inner cover.

In the embodiment, the second recess of the upper inner cover is formed within an area of the first recess of the upper inner cover and wherein the second recess of the lower inner cover is formed within an area of the first recess of the lower inner cover. In the embodiment, the first gear is integrally formed within the upper outer cover and wherein the second gear is integrally formed within the lower outer cover.

In the embodiment, the method further comprises: fixing the first resilient member within the upper inner cover by ultrasonic welding; and fixing the second resilient member within the lower inner cover by ultrasonic welding. In the embodiment, the method further comprises: fixing the upper outer cover to the lower outer cover by ultrasonic welding. In the embodiment, the method further comprises: fixing the upper outer cover to the lower outer cover by an adhesive.

Although embodiments of the present disclosure have been illustrated in conjunction with the accompanying drawings and described in the foregoing detailed description, it should be appreciated that the invention is not limited to the embodiments disclosed and is capable of numerous rearrangements, modifications, alternatives, and substitutions without departing from the spirit of the disclosure as set forth and recited by the following claims.

What is claimed:

1. A power/signal connector, comprising:
a fixing part for connection to an inlet comprising:
a housing portion having a set of terminals mounted in the housing portion for terminating conduits;
an upper inner cover with recesses formed therein for receiving a first resilient member and a first gear;
a lower inner cover with recesses formed therein for receiving a second resilient member and a second gear; and
a rotating part being rotatable relative to the fixing part at three or more predetermined positions, the rotating part including:
an upper outer cover having the first gear;
a lower outer cover having the second gear;
the first resilient member; and
the second resilient member.

2. The power/signal connector of claim 1, wherein the fixing part further includes a resilient locking member for locking the fixing part relative to the inlet.

3. The power/signal connector of claim 1, wherein a first recess among the recesses formed in each of the inner covers includes a substantially rectangular-shaped recess and a substantially circular recess.

4. The power/signal connector of claim 1, wherein each of the inner covers further comprises a pair of pillars for positioning each of the resilient members within the recesses.

5. The power/signal connector of claim 4, wherein each of the resilient members has a pair of circular holes formed therein for mating with the pair of pillars.

6. The power/signal connector of claim 1, wherein each of the gears includes a plurality of teeth with notches formed between a pair of teeth, at least one notch and a corresponding pair of teeth being configured to engage with a corresponding one of the resilient members so as to resiliently hold the fixing part at one of the three or more predetermined positions.

7. The power/signal connector of claim 6, wherein each of the resilient members includes a pair of opposing tips for engaging with a pair of opposing notches and corresponding pairs of opposing teeth.

8. The power/signal connector of claim 6, wherein a position among the three or more predetermined positions is a straight line along a length of the fixing part and a length of the rotating part.

9. The power/signal connector of claim 6, wherein a position among the three or more predetermined positions is a 45 degree angle between a length of the fixing part and right of a length of the rotating part.

10. The power/signal connector of claim 6, wherein a position among the three or more predetermined positions is a 45 degree angle between a length of the fixing part and left of a length of the rotating part.

11. The power/signal connector of claim 6, wherein a position among the three or more predetermined positions is a 90 degree angle between a length of the fixing part and right of a length of the rotating part.

12. The power/signal connector of claim 6, wherein a position among the three or more predetermined positions is a 90 degree angle between a length of the fixing part and left of a length of the rotating part.

13. A method for assembling a rotatable power/signal connector, comprising:
assembling a first resilient member on an upper inner cover by fitting the first resilient member into a first recess formed within the upper inner cover;
assembling a second resilient member on a lower inner cover by fitting the second resilient member into a first recess formed within the lower inner cover;
assembling an upper outer cover over the upper inner cover by fitting a first gear into a second recess formed within the upper inner cover; and
assembling a lower outer cover over the lower inner cover by fitting a second gear into a second recess provided within the lower inner cover.

14. The method of claim 13, wherein the second recess of the upper inner cover is formed within an area of the first recess of the upper inner cover and wherein the second recess of the lower inner cover is formed within an area of the first recess of the lower inner cover.

15. The method of claim 14, wherein the first gear is integrally formed within the upper outer cover and wherein the second gear is integrally formed within the lower outer cover.

16. The method of claim 13, further comprising:
fixing the first resilient member within the upper inner cover by ultrasonic welding; and
fixing the second resilient member within the lower inner cover by ultrasonic welding.

17. The method of claim 13, further comprising:
fixing the upper outer cover to the lower outer cover by ultrasonic welding.

18. The method of claim 13, further comprising:
fixing the upper outer cover to the lower outer cover by an adhesive.
